(19) United States
(12) Patent Application Publication
(10) Pub. No.: US 2017/0065838 A1
(43) Pub. Date: Mar. 9, 2017

(54) FILTERING FACEMASK HOLDER

(71) Applicant: Masket, LLC, Shoreview, MN (US)

(72) Inventors: Max Jacob Bunge, Shoreview, MN (US); Alain Chad Vallet-Sandre, Apple Valley, MN (US)

(21) Appl. No.: 15/261,534

(22) Filed: Sep. 9, 2016

Related U.S. Application Data
(60) Provisional application No. 62/216,357, filed on Sep. 9, 2015.

(51) Int. Cl. A62B 18/08; A62B 9/04; A41D 13/11; A62B 23/02

(52) U.S. Cl. CPC A62B 18/084; A62B 23/025; A62B 9/04; A41D 13/1138; A41D 13/1161

(57) ABSTRACT

A filtering facemask holder includes a first and a second body portion each having a front and a rear. Additionally, each first and second body portion includes a central opening. The front of the second body portion is configured to receive the rear of the first body portion. The facemask holder also includes a face seal disposed around an outer edge of the rear of the second body portion.

### CROSS-REFERENCE TO RELATED APPLICATIONS

This application claims priority to U.S. Provisional Application Ser. No. 62/216,357 filed on Sep. 9, 2015, and titled A FILTERING FACEMASK HOLDER, the content of which is hereby incorporated by reference in its entirety.

### BACKGROUND

Traditionally, disposable filtering facemasks have been used in environments where airborne particulates pose an inhalation risk (e.g. hospitals or construction sites). The term “respirator” is often applied to a closely fitting filtering disposable facemask that has a relatively high filtration efficiency and that is used in areas where protection is desired from inhalation of sub-micron particulates that tend to remain suspended in the atmosphere for relatively long periods.

Recently, using disposable facemasks in public in densely populated cities has become more common. This is often driven by poor air equality, contaminated with pollution, and the fear of contracting airborne illnesses.

The construction of many disposable facemasks is often flimsy due to the fact that they are designed to be cost effective and disposable. Due to this, many disposable filtering facemasks create poor seals with the wearer's face and often cause the wearer discomfort.

### SUMMARY

In general terms, this disclosure is directed to a filtering facemask holder. In one possible configuration and by non-limiting example, this disclosure relates to a filtering facemask holder that has a seal and a two-piece housing configured to receive a disposable filtering mask. Various aspects are described in this disclosure, which include, but are not limited to, the following aspects.

One aspect is a filtering facemask holder that includes a first and a second body portion each having a front and a rear. Additionally, each first and second body portion includes a central opening. The front of the second body portion is configured to receive the rear of the first body portion. The facemask holder also includes a face seal disposed around an outer edge of the rear of the second body portion.

Another aspect is a filtering facemask holder that includes a body portion that has a central opening. The central opening is configured to hold a disposable facemask. The facemask holder also includes a one-way exhaust vent provided through the body portion and a face seal disposed around an outer edge of the body portion.

Another aspect is a filtering facemask holder that includes a first and a second body portion that each has a front and a rear. Each first and a second body portion also include a central opening. The front of the second body portion is configured to receive the rear of the first body portion, and the first body portion and second body portion are pivotable about a hinge. The facemask holder also includes a face seal disposed around an outer edge of the rear of the second body portion and an exhaust vent that is provided through the first and second body portions. The exhaust vent is a one way vent and includes an exhaust membrane positioned within the exhaust vent. Further, the facemask holder includes a head securing strap attached to at least the first body portion.

### BRIEF DESCRIPTION OF THE DRAWINGS

FIG. 1A illustrates a side perspective view of a wearer wearing a facemask holder that includes a disposable facemask, according to one embodiment of the present disclosure.

FIG. 1B illustrates a front perspective view of the wearer wearing the facemask holder of FIG. 1;

FIG. 2 illustrates a front perspective view of the facemask holder of FIG. 1.

FIG. 3 illustrates a rear perspective view of the facemask holder of FIG. 1.

FIG. 4 illustrates a cross-sectional side view of the facemask holder of FIG. 1 worn on a wearer's face.

FIG. 5 illustrates an exploded view of an exhaust vent of the facemask holder of FIG. 1.

FIG. 6 illustrates a cross-sectional side view of an exhaust vent of the facemask holder of FIG. 1.

FIG. 7 illustrates a perspective view of an outer portion, an inner portion, and a face seal of the facemask holder of FIG. 1.

FIG. 8 illustrates a front perspective view of the facemask holder of FIG. 1 in the open position.

FIG. 9 illustrates a rear perspective view of the facemask holder of FIG. 1 in the open position.

FIG. 10 illustrates a side perspective view of the facemask holder of FIG. 1 in the open position.

FIG. 11 illustrates a disposable facemask prior to being inserted into the facemask holder of FIG. 1, according to one embodiment of the present disclosure.

FIG. 12 illustrates the installation process of the disposable facemask within the facemask holder, according to one embodiment of the present disclosure.

FIG. 13 illustrates the facemask holder and the disposable facemask fully assembled together, according to one embodiment of the present disclosure.

FIG. 14 illustrates a cross-sectional view of the facemask holder of FIG. 1 with a disposable mask installed.

FIG. 15 illustrates a perspective view of a first example strap and facemask holder, according to one embodiment of the present disclosure.

FIG. 16 illustrates a rear view of the first example strap and facemask holder of FIG. 15 fully assembled with one another, according to one embodiment of the present disclosure.

FIG. 17 illustrates a perspective view of a second example strap used for holding a facemask holder against the wearer's face, according to one embodiment of the present disclosure.

FIG. 18 illustrates a perspective view of a third example strap used for holding a facemask holder against the wearer's face, according to one embodiment of the present disclosure.

FIG. 19 illustrates a perspective view of a fourth example strap used for holding a facemask holder against the wearer's face, according to one embodiment of the present disclosure.

FIG. 20 illustrates a perspective view of a fifth example strap used for holding a facemask holder against the wearer's face, according to one embodiment of the present disclosure.

FIG. 21 illustrates a perspective view of a sixth example strap used for holding a facemask holder against the wearer's face, according to one embodiment of the present disclosure.

FIG. 22 illustrates a perspective view of a seventh example strap used for holding a facemask holder against the wearer's face, according to one embodiment of the present disclosure.

### DETAILED DESCRIPTION

Various embodiments will be described in detail with reference to the drawings, wherein like reference numerals represent like parts and assemblies throughout the several views. Reference to various embodiments does not limit the scope of the claims attached hereto. Additionally, any examples set forth in this specification are not intended to be limiting and merely set forth some of the many possible embodiments for the appended claims.

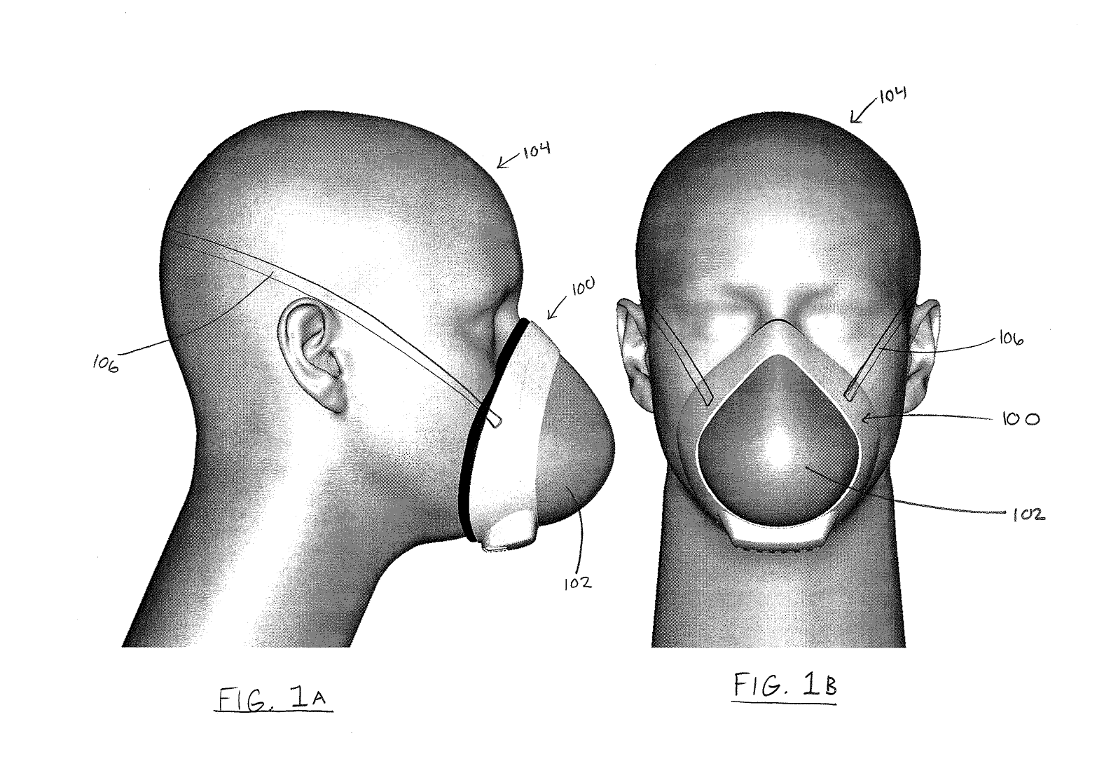

FIGS. 1A and 1B are side and front views, respectively, of an example of a filtering facemask holder 100, that includes a disposable facemask 102 attached to a wearer's face 104. The facemask holder 100 is shown to cover the nose and mouth of the wearer's face 104. In this example, the holder 100 includes a strap 106 that secures the holder 100 to the wearer's face 104. In some embodiments, the holder 100 does not include a strap 106.

The holder 100 is configured to hold the disposable facemask 102 while providing a comfortable wearing experience for the wearer. Additionally, the holder 100 is designed to improve the seal between the wearer's face 104 and the holder 100 in addition to reducing condensation buildup inside of the disposable facemask 102.

The holder 100 is designed to be used when particulates exist in the air that the wearer does not want to inhale. Particulates can exist in environments such as in a city, at a construction site, in a work shop, or in an outdoor environment. Such particulates may be seen as potential health hazards by the wearer and it is important to filter such particulates from the air prior to inhalation. In order to filter air properly for inhalation, the holder 100 is configured to be placed over the wearer's nose and mouth and form a seal with the wearer's face 104. In some embodiments, the holder 100 covers just the wearer's mouth.

In some embodiments, the holder 100 is at least partially ornamental in nature and features nonfunctional elements. For example, the holder 100 can have an outer curved profile.

The disposable facemask 102 can be a variety of different types of disposable facemasks. In some embodiments, the disposable facemask 102 is cup shaped. In some embodiments, the disposable facemask 102 includes a fibrous web layer for filtering. The disposable facemask 102 can have different thicknesses and a range of abilities to prevent contact with liquids. These properties may also affect how easy the disposable facemask 102 is to breathe through and how well the disposable facemask 102 protects the wearer. The disposable facemask 102 is also meant to help block particle droplets, splashes, sprays or splatter that may contain germs (viruses and bacteria), keeping it from reaching the wearer's mouth and/or nose. The facemask 102 may also help reduce exposure of the wearer's saliva and respiratory secretions to others.

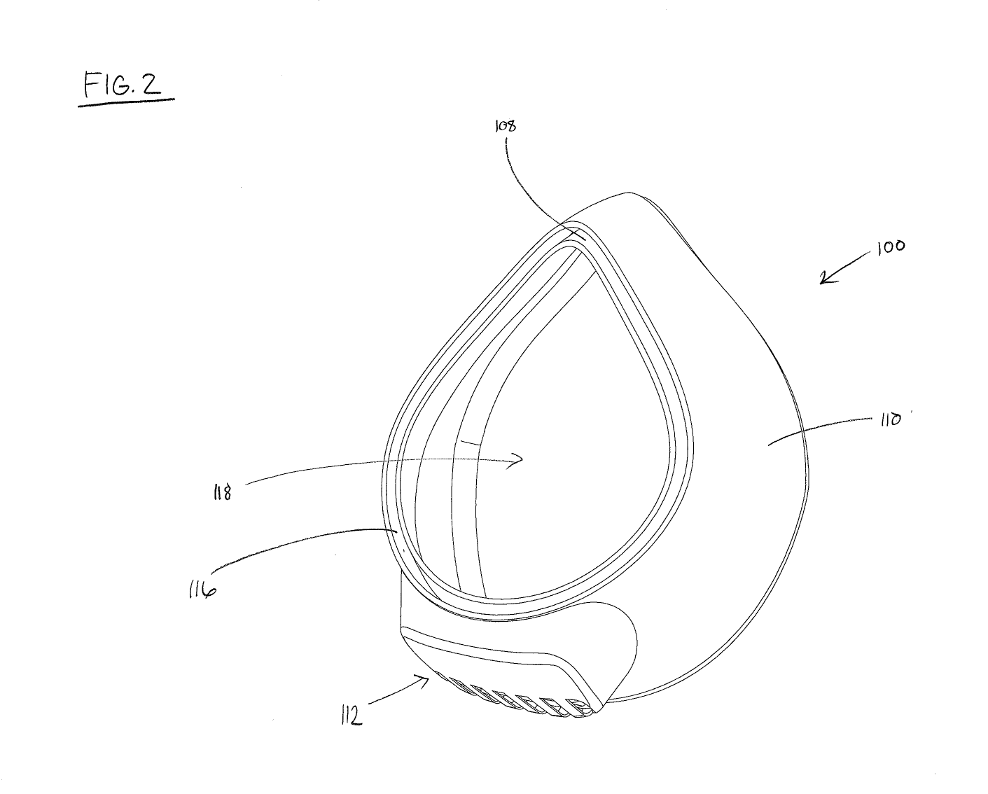

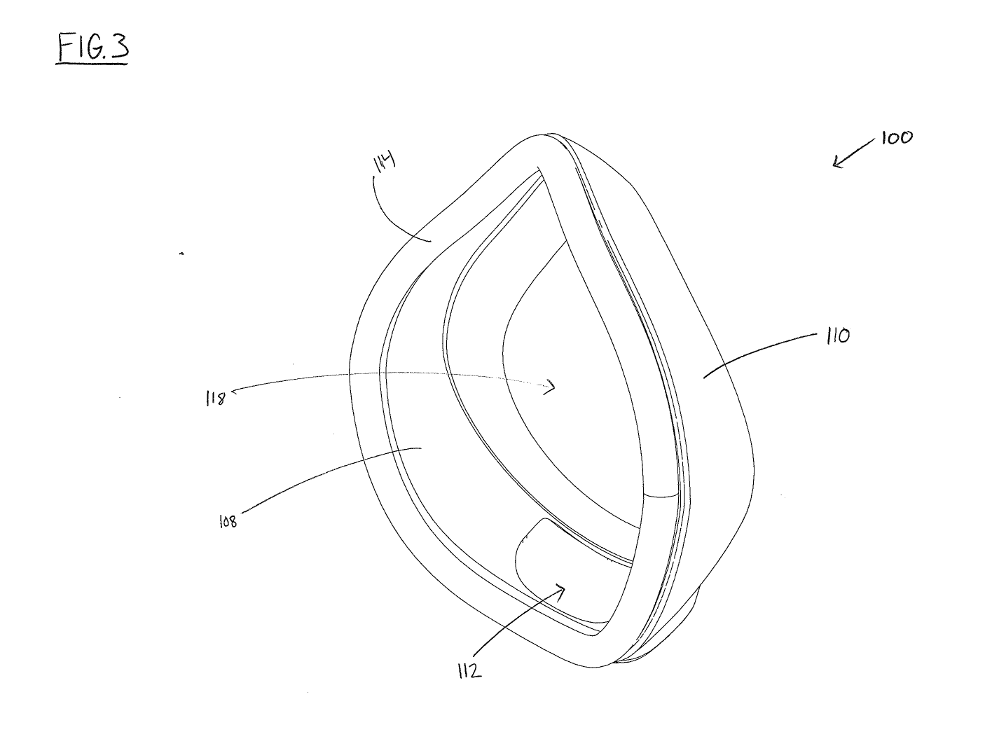

FIGS. 2 and 3 show front and rear perspective views of the holder 100, respectively, without the disposable facemask 102. For illustrative purposes, the holder 100 is also shown without a strap 106. As shown, the holder 100 includes an inner body portion 108 and an outer body portion 110 that are stacked on top of one another. Additionally, the holder 100 includes an exhaust vent 112 provided through the inner and outer body portions 108, 110. Finally, a face seal 114 is disposed around a rear of the holder 100.

The inner and outer body portions 108, 110 are configured to be stackable on top of one another. Further, when stacked upon one another, the inner and outer body portions 108, 110 define an internal cavity 116, as can be seen in FIG. 2. The internal cavity 116 is positioned between the inner and outer body portions 108, 110 and is sized to receive a portion of the disposable facemask 102. In some embodiments, the internal cavity 116 can be sized to accept a variety of differently sized disposable filter facemasks.

The holder 100 also includes a central opening 118 passing through both the inner and outer body portions 108, 110. The central opening 118 has an area smaller than that of the disposable facemask 102. This is so that the disposable facemask 102 rests within the internal cavity 116 and also covers the entire central opening 118 when inserted into the holder 100. The smaller area of the central opening 118 also helps to retain the disposable facemask 102 within the holder 100 and in the internal cavity 116.

The exhaust vent 112 of the holder 100 provides a pathway for exhaled air from the wearer to escape the holder 100 when the disposable facemask 102 is installed. When using traditional disposable masks, exhaled air travels back through the disposable mask and to outside of the mask. However, moisture tends to become trapped within traditional disposable masks against the wearer's face 104, and, after some time passes, the disposable mask becomes saturated with moisture. This causes the mask to become less effective and uncomfortable for the wearer. However, in the depicted embodiment, the exhaust vent 112 of the holder 100 allows hot moist exhaled air to pass through the vent and to the outside of the holder 100 when the disposable facemask 102 is installed within the holder 100. This improves the overall lifetime of the disposable facemask 102 when installed within the holder 100 and also makes the holder 100 more comfortable for the user.

The face seal 114 of the holder 100 forms a seal between the holder 100 and the wearer's face 104. In some embodiments, the face seal 114 is movable and configured to conform to many different facial structures. Additionally, the face seal 114 is constructed of a material that limits air passage through the seal. In some embodiments, the face seal 114 is a soft rubber. The face seal 114 is configured to maintain a comfortable, effective seal against the wearer's face 104 regardless of the moisture content within the holder 100 and the disposable facemask 102 when worn on the wearer's face 104. This allows the wearer to wear the holder 100 with the disposable facemask 102 for longer periods of time, and it also allows the holder 100 to be repeatedly worn while maintaining a consistent seal with the wearer's face 104. This is unlike a traditional disposable mask, as the traditional disposable mask is meant for a single use and multiple uses will often lead to the breakdown of the rigidity of the disposable mask that leads to poor filtration performance and a poor seal with the wearer's face 104.

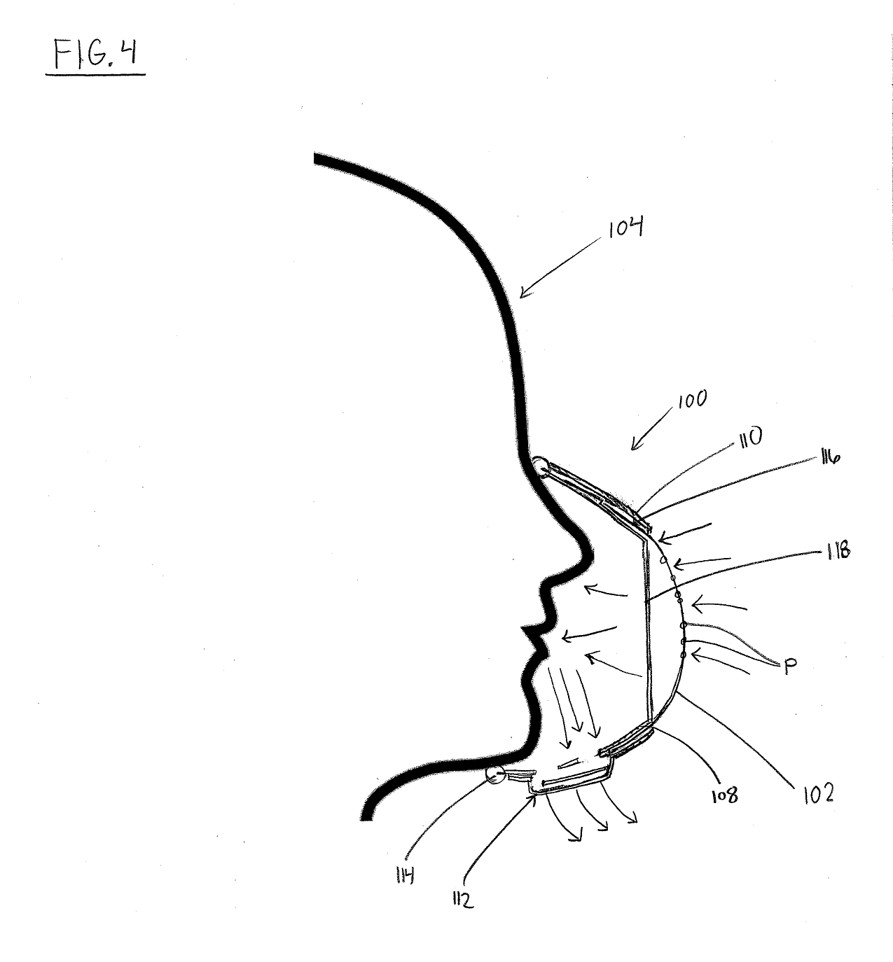

FIG. 4 shows a cross-sectional view of the holder 100 and the disposable facemask 102 when being worn on the wearer's face 104. The disposable facemask 102 is shown partially positioned within the internal cavity 116 of the holder 100 and completely covering the central opening 118. As shown, because the central opening 118 is smaller than the disposable facemask 102, the disposable facemask 102 is retained within the holder 100.

Arrows are used to show air flow with respect to the wearer's face 104 when the wearer is inhaling and exhaling. As shown, air is brought to the wearer's mouth and nose through the disposable facemask 102 that is positioned over the central opening 118 of the holder 100. The disposable facemask 102 filters particulates P from the incoming air. As can be seen from the arrows, air is supplied to the mouth and nose of the wearer only through the disposable facemask 102 and not from around the face seal 114 or through the exhaust vent 112.

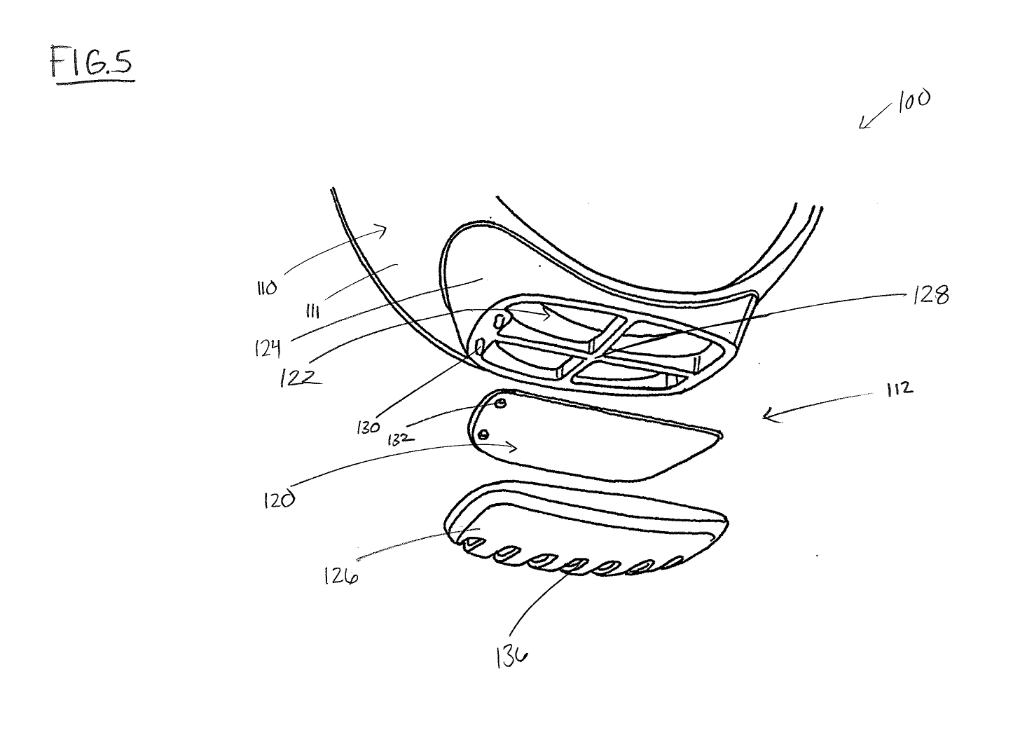

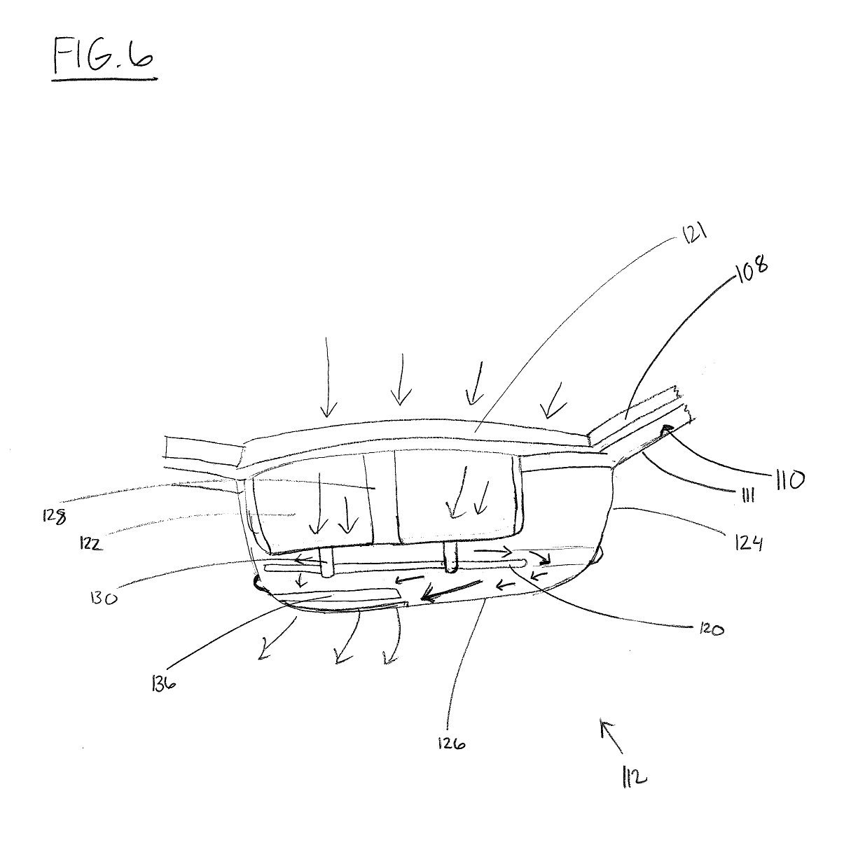

When air is exhaled by the wearer, the exhaled air passes through the exhaust vent 112 to the outside of the holder 100 and the disposable facemask 102. The exhaust vent 112 is configured to be a one-way vent, only allowing air to escape from inside of the holder 100 and disposable facemask 102 and not allowing air to enter from outside of the holder 100 and disposable facemask 102. In some embodiments, the exhaust vent 112 includes an internal membrane 120 that opens the vent for exhaled air, but closes the vent to inhaled air. The membrane 120 will be described in more detail with respect to the FIGS. 5 and 6.

FIG. 5 shows an exploded view of the exhaust vent 112. As shown, the exhaust vent 112 includes an aperture 122 defined by a housing 124, the membrane 120, and a cover 126. While only the outer portion 110 of the holder 100 is shown, the inner portion 108 also includes an aperture (121 shown in FIG. 6) that aligns with the aperture 122 of the outer portion 110.

The housing 124 of the aperture 122 of the outer portion 110 is shown to protrude from an outer surface 111 of the outer portion 110. This allows the outer portion 110, and the holder 100 in general, to be sized smaller so the exhaust vent 112 is not occupying space in the interior of the holder 100. Further, the exhaust vent 112 includes dividers 128 within the aperture 122 to prevent inadvertent damage to the exhaust vent 112, specifically to the membrane 120 (e.g., from a finger poke). The housing 124 also includes a pair of pegs 130 that are configured to receive the membrane 120.

The membrane 120 is movable within the exhaust vent 112 along the pegs 130 of the housing 124. When air is inhaled into the holder 100 through the disposable facemask 102, the membrane 120 is forced against the aperture 122 by the vacuum force caused by the wearer's inhalation. When against the aperture 122, the membrane 120 prevents unfiltered air from entering through the exhaust vent 112. When air is exhaled by the wearer, the force of the air moves the membrane 120 to the end of the pegs 130 and allows air to escape through the aperture 122 and out through the cover 126.

The membrane 120 is made from a flexible material. The membrane 120 can be made from an elastomeric material such as a crosslinked natural rubber (for example, crosslinked polyisoprene) or a synthetic elastomer such as neoprene, butyl rubber, nitrile rubber, or silicone rubber. In some embodiments, the membrane 120 provides a leak-free seal meeting the federal minimum requirements for exhalation valve leakage. In some embodiments, the membrane 120 may be cut from a flat sheet of material having a generally uniform thickness. In the depicted embodiment, the membrane 120 is cut in the general shape of a rectangle, and includes a pair of holes 132 that are sized to receive the pegs 130 of the housing 124.

The cover 126 is attached to the housing 124 so as to protect the exhaust vent 112 from inadvertent damage. The cover 126 includes a plurality of holes 136 that allow exhaled air to pass through.

FIG. 6 shows a cross-sectional view of the exhaust vent 112 during an exhale of air by the wearer. During an exhale, air (movement shown by arrows) travels through the aperture 121 of the inner portion 108 of the holder 100 and into the aperture 122 of the outer portion 110. The exhaled air forces the membrane 120 to the end of the pegs 130 of the housing 124 which opens a passage for the exhaled air to pass around the membrane 120. Once around the membrane 120, the exhaled air can then pass through the holes 136 of the cover 126.

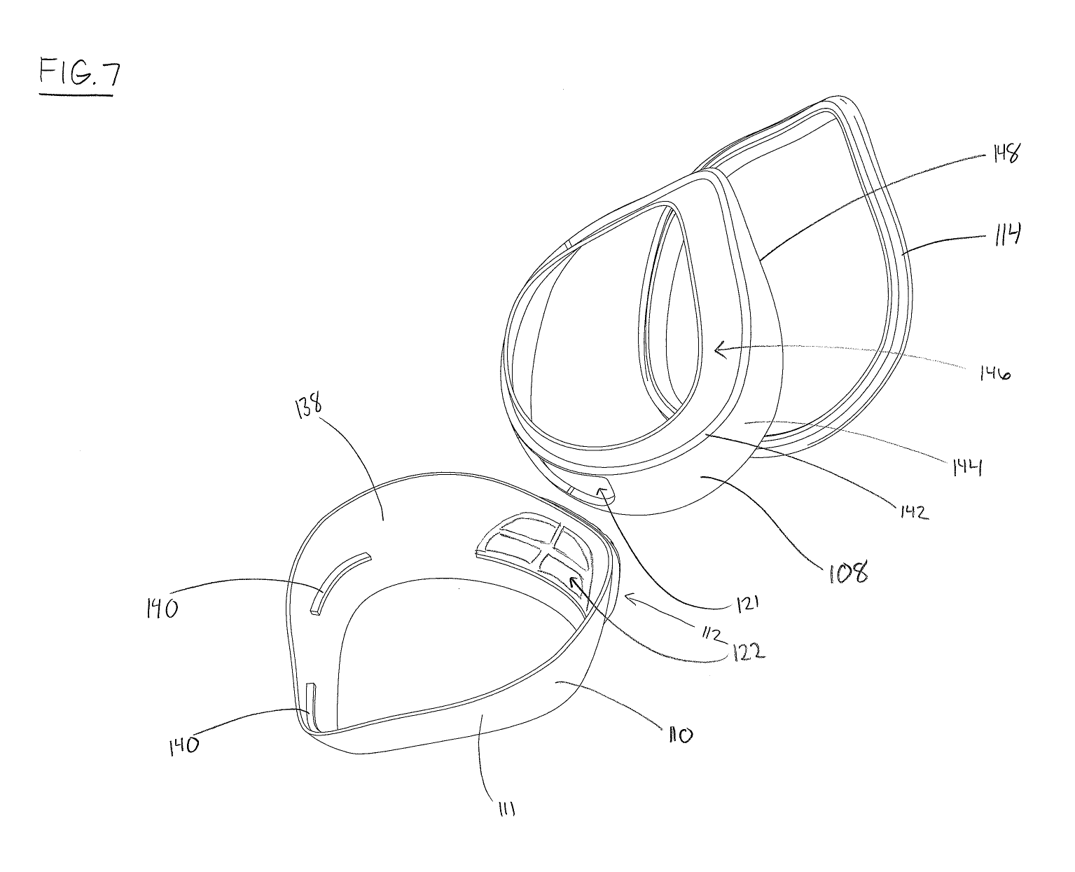

FIG. 7 shows the inner and outer portions 108, 110 and the face seal 114 of the holder 100 separated from one another.

As shown, in addition to an outer surface 111 and aperture 122 of the exhaust vent 112, the outer portion 110 also includes an inner surface 138. The inner surface 138 also includes a plurality of protrusions 140. The protrusions 140 are configured to help position the disposable facemask 102 within the outer portion 110. In some embodiments, the protrusions 140 help secure the outer portion 110 with the inner portion 108 when the holder 100 is assembled. In still other embodiments, the protrusions 140 help to secure the disposable facemask 102 within the internal cavity 116 defined by the inner and outer portions 108, 110. In still other embodiments, the protrusions 140 prevent the disposable facemask 102 from inadvertently covering the exhaust vent 112.

The inner portion 108 of the holder 100 includes a ridge 142 disposed on an outer surface 144 thereof. The ridge 142 helps to define a recessed portion 146 of the outer surface 144 of the inner portion 108. In some embodiments, the ridge 142 is positioned on the outer surface 144 so as to receive the protrusions 140 of the outer portion 110 when the holder 100 is assembled. Also, in some embodiments, the recessed portion 146 of the inner portion 108 helps to define the internal cavity 116 of the holder 100 that is configured to receive the disposable facemask 102. The overall size of the inner portion 108 is sized so that the outer portion 110 is stackable on top of the inner portion 108.

The inner portion 108 also includes a rear edge 148 that lies closest to the wearer's face 104 when the holder 100 is worn by the wearer. The rear edge 148 receives the face seal 114. In some embodiments, the face seal 114 is press fit onto the rear edge 148. In other embodiments, the face seal 114 is adhered to the rear edge 148.

The inner and outer portions 108, 110 are constructed of a rigid material. In some embodiments, the inner and outer portions 108, 110 are constructed of a plastic. By non-limiting example, the inner and outer portions 108, 110 can be constructed of high-density polyethylene (HDPE), polyvinyl chloride (PVC), polypropylene, or acrylonitrile butadiene styrene (ABS).

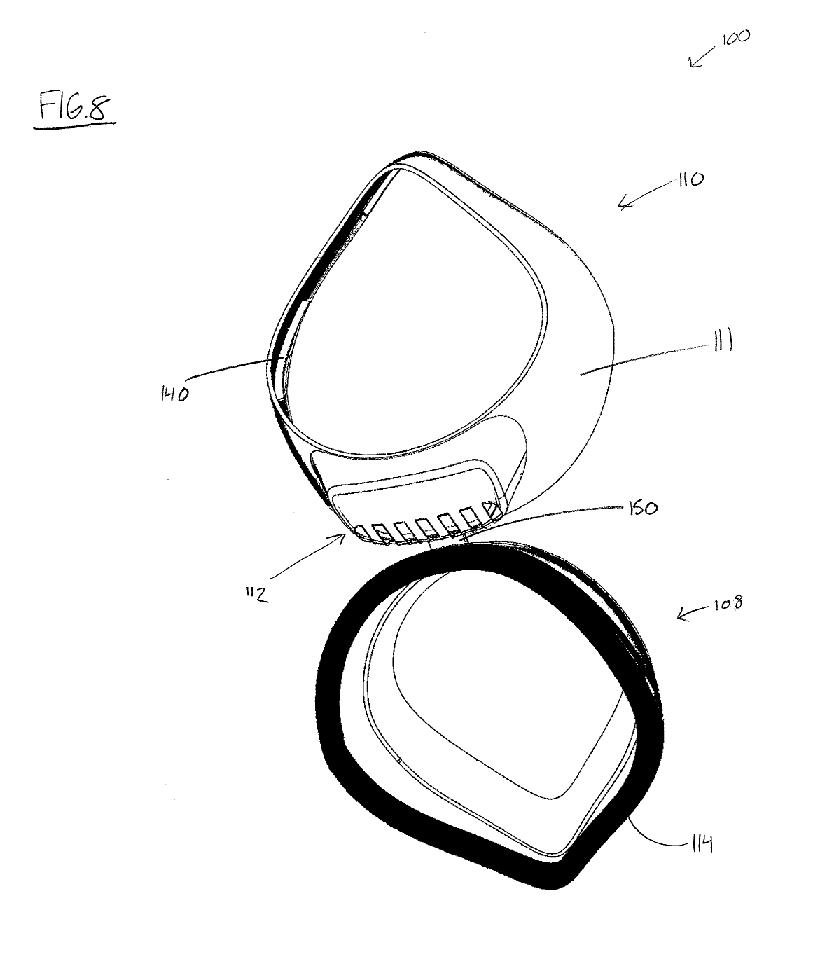

FIGS. 8-10 show the holder 100 in an open position, ready to receive the disposable facemask 102. The inner and outer portions 108, 110 are connected to one another by way of a hinge 150. In the depicted embodiment, the hinge 150 is a living hinge. The living hinge 150 is a thin flexible hinge made from the same material as the inner and outer portion 108, 110. The inner and outer portions 108, 110 are pivotable about the hinge 150 and about one another. In some embodiments, the hinge 150 is a separate part and attached to both the inner and outer portions 108, 110.

FIG. 8 shows a front perspective view of the outer portion 110 and a rear perspective view of the inner portion 108 of the holder 100 in the open position.

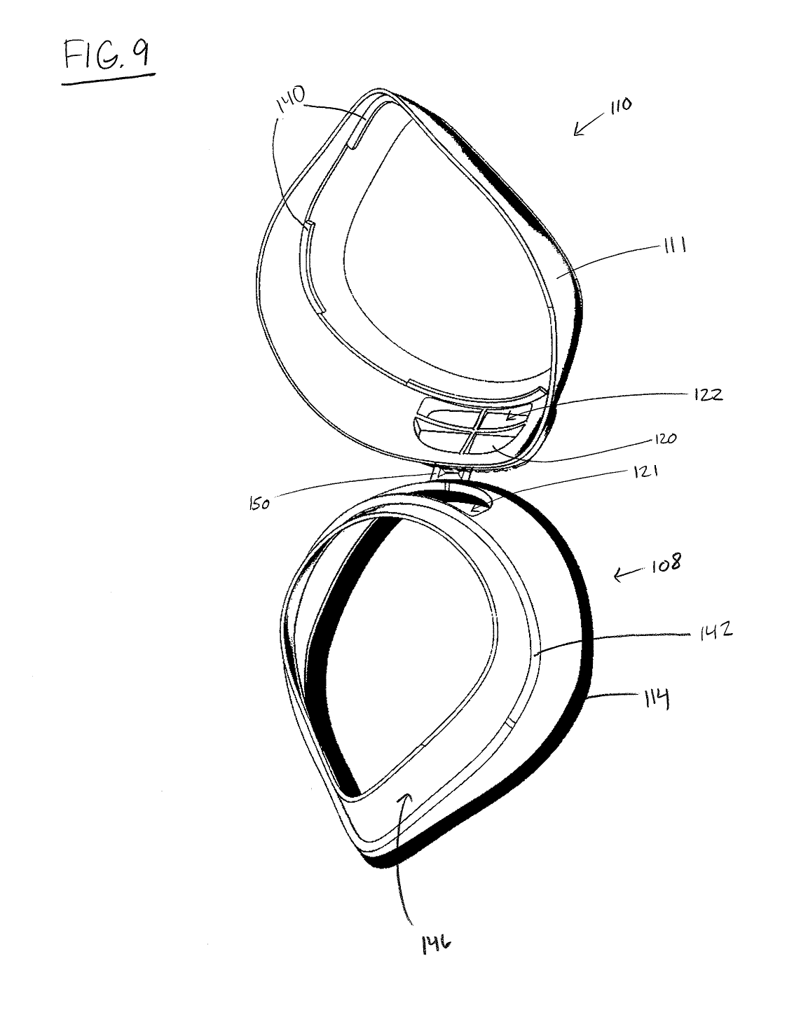

FIG. 9 shows a rear perspective view of the outer portion 110 and a front perspective view of the inner portion 108 of the holder 100 in the open position.

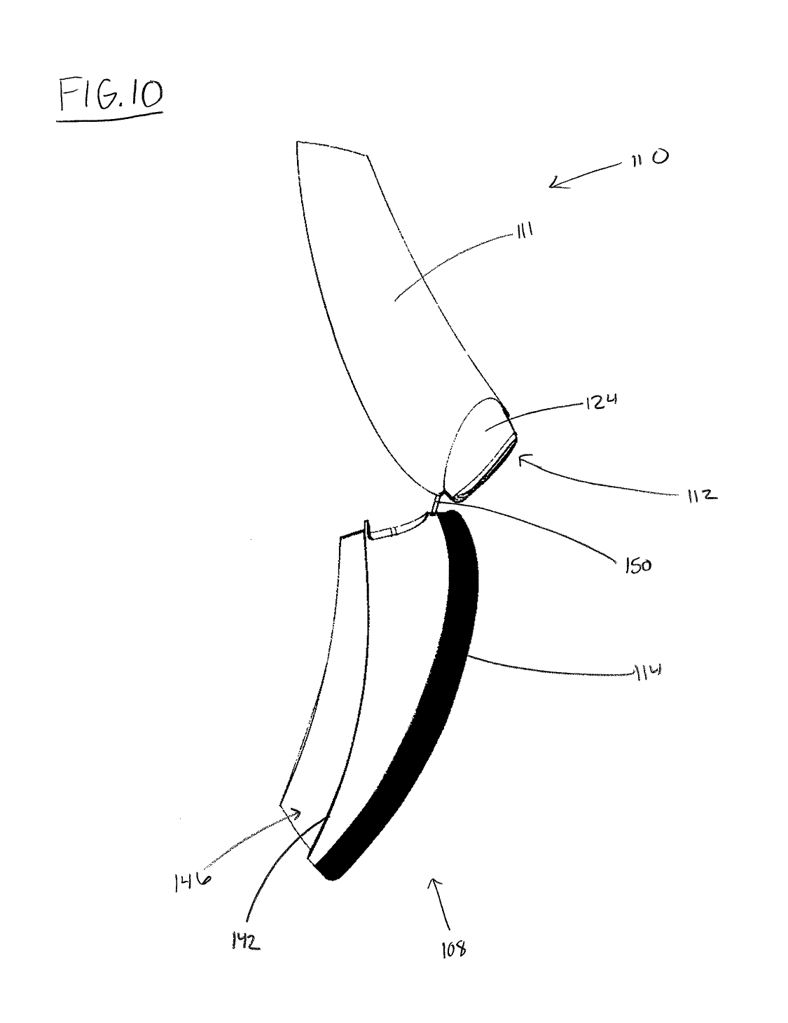

FIG. 10 shows a side view of the outer portion 110 and the inner portion 108 of the holder 100 in the open position.

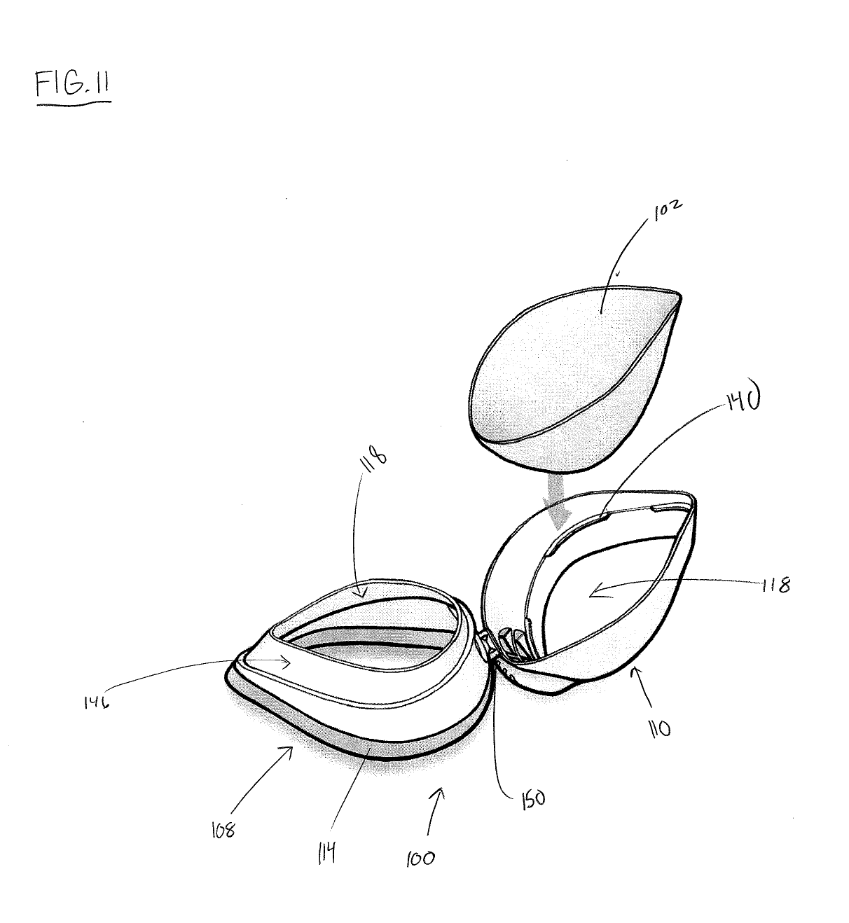

FIGS. 11-13 show the installation process of inserting the disposable facemask 102 into the holder 100. To insert the disposable facemask 102, the holder 100 needs to be in the open position, as shown in FIG. 11. To move the holder 100 to the open position, the inner and outer portions 108, 110 are pivoted about one another about the hinge 150, until the outer portion 110 is no longer stacked on top of the inner portion 108.

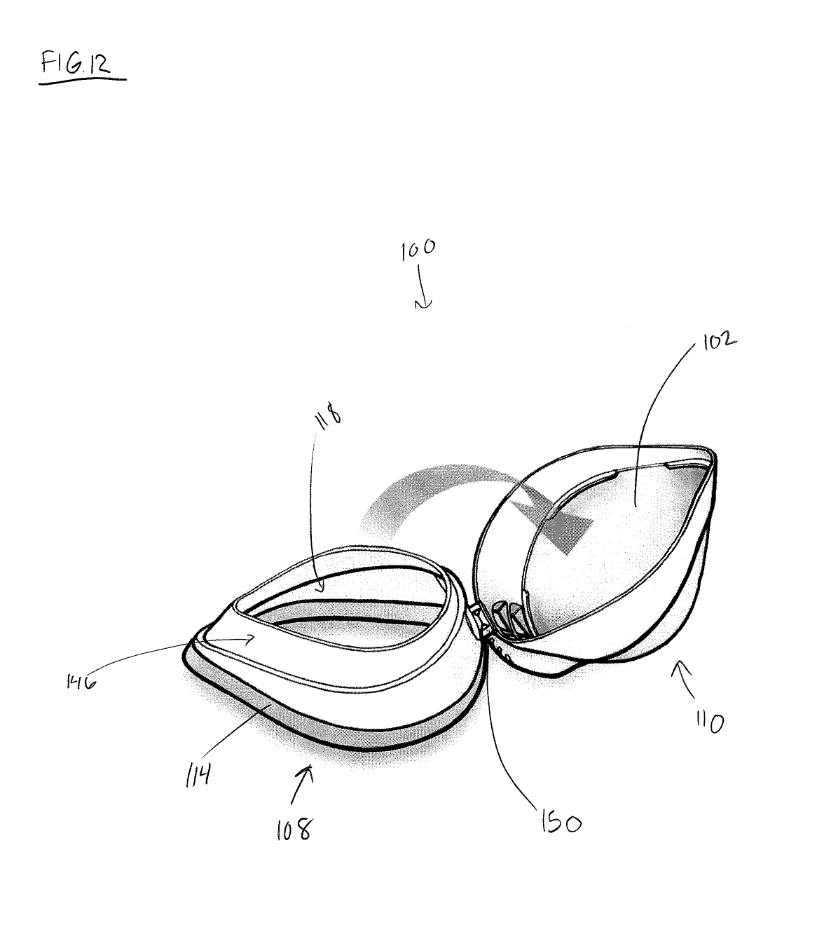

The disposable facemask 102 is loaded into the holder 100 so that it rests between the inner and outer portions 108, 110 when the holder 100 is in a closed position. In the depicted embodiment, the disposable facemask 102 is loaded into the outer portion 110 so that the disposable facemask 102 covers the central opening 118. As shown in FIG. 12, the disposable facemask 102 is inserted into the outer portion 110 and seated in front of the securing protrusions 140. In other embodiments, the disposable facemask 102 is seated behind the securing protrusions 140. In other embodiments still, the disposable facemask 102 is positioned on the recessed portion 146 of the inner portion 108 when the holder 100 is in the open position.

Once positioned within the outer portion 110 or on the recessed portion 146 of the inner portion 108, the inner and outer portions 108, 110 are pivoted about the hinge 150 toward one another, as shown in FIG. 12. In the depicted embodiment, the inner portion 108 is pivoted toward the outer portion 110 so that the disposable facemask 102 does not fall out of the outer portion 110. When in the closed position, the disposable facemask 102 covers the entire central opening 118.

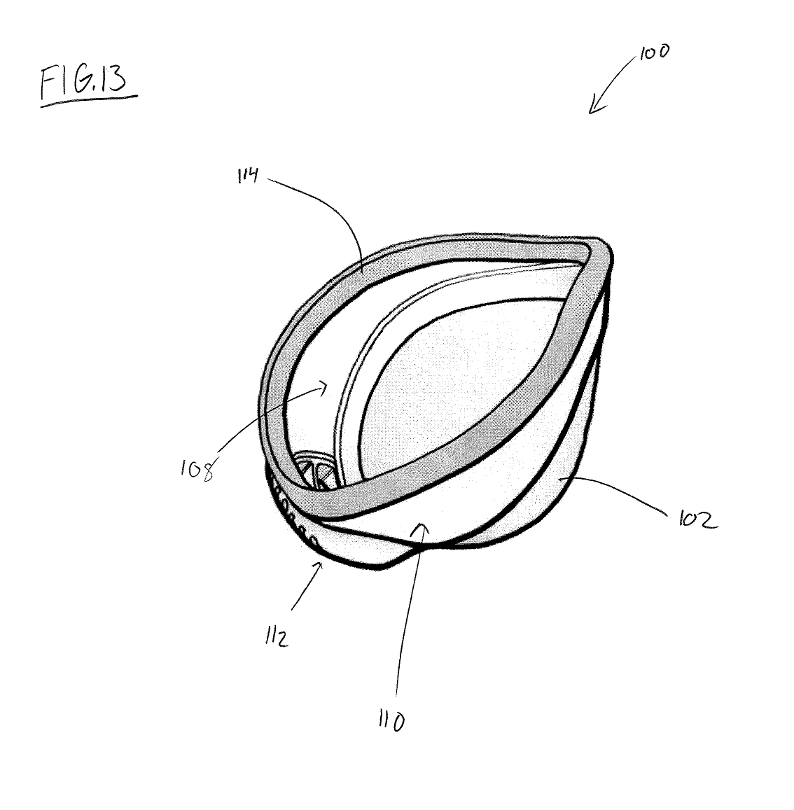

FIG. 13 shows the holder 100 in the closed position with the disposable facemask 102 secured within. In some embodiments, the holder 100 can include a latch (not shown) that keeps the inner and outer portions 108,110 in a stacked orientation and the holder 100 in the close position. In some embodiments, the latch can be positioned on the outside of the holder 100. In other embodiments, the latch is positioned inside of the holder 100.

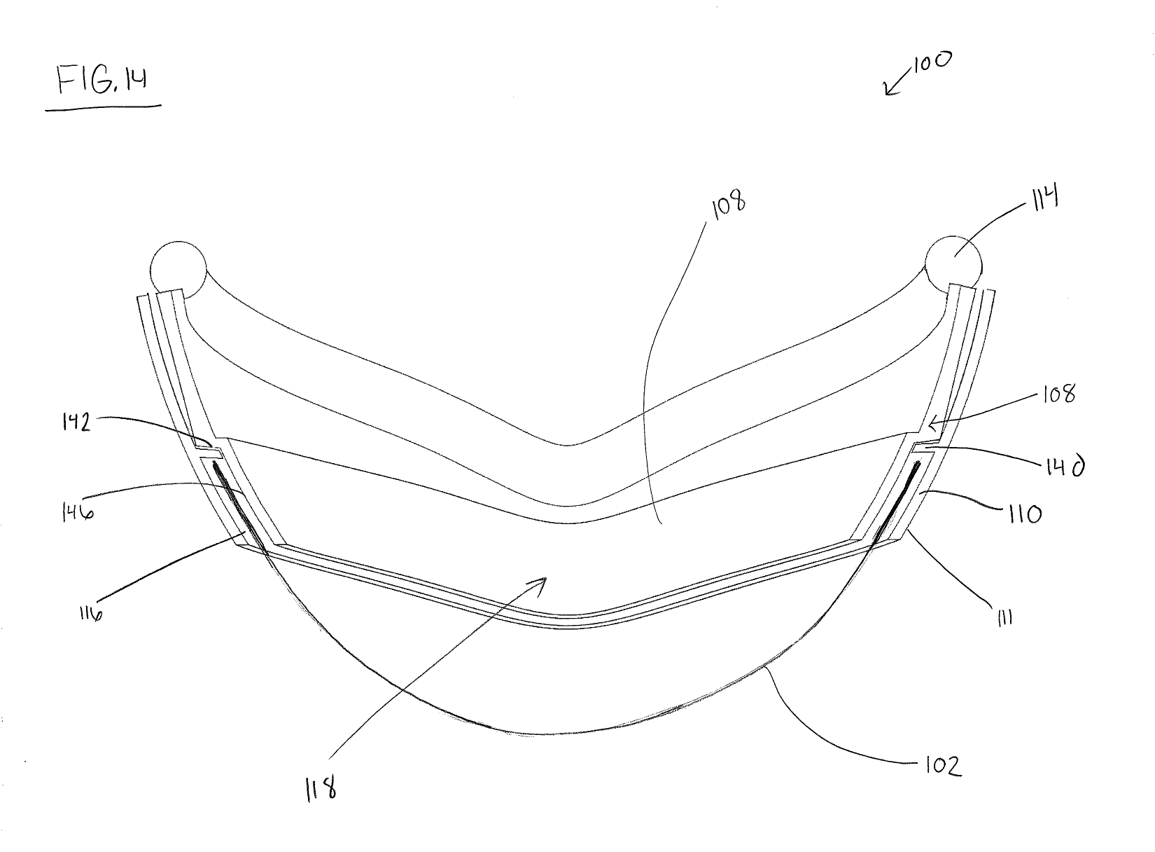

FIG. 14 shows a cross-sectional view of the holder 100 with the disposable facemask 102 installed. In the depicted embodiment, the protrusions 140 of the outer portion 110 are shown seated on the ridge 142 of the inner portion 108. As shown, when in the closed position, the holder 100, and specifically the inner and outer portions 108, 110 define the internal cavity 116 that holds the disposable facemask 102 therein. In some embodiments, the disposable facemask 102 is pinched between the protrusions 140 and the ridge 142 while remaining positioned within the internal cavity 116. In some embodiments, the inner portion 108 includes a protrusion (not shown) instead of a ridge 142. In such an embodiment, the protrusions of both the inner and outer portions 108, 110 can overlap and latch the holder 100 in a closed position.

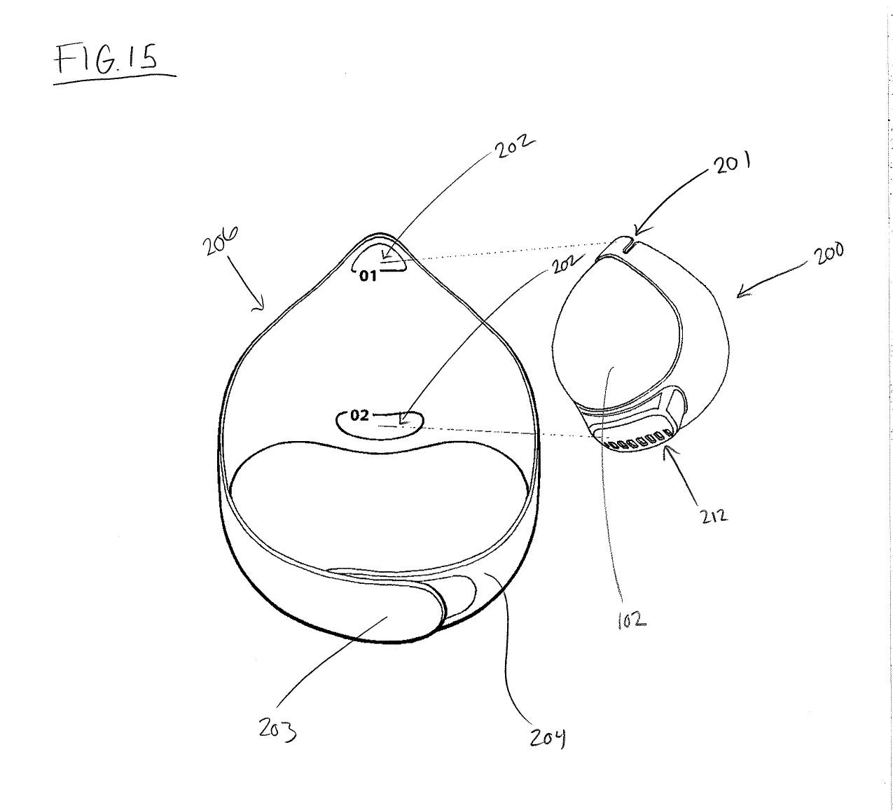

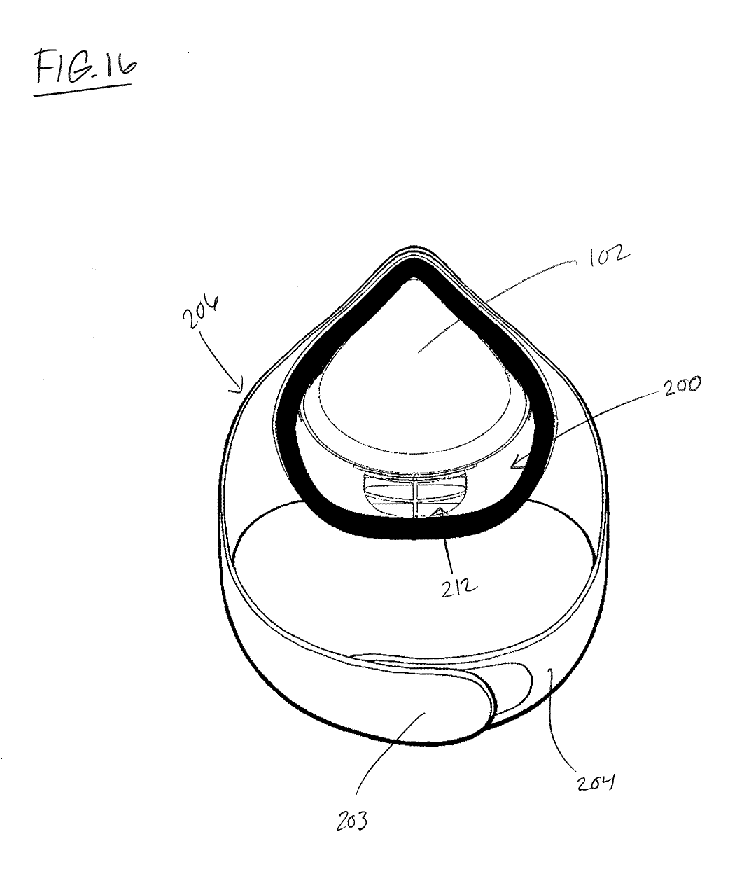

FIGS. 15-16 show an example strap 206 that is configured to secure a holder 200 to the wearer's head. The holder 200 is another example of the holder 100. In the depicted embodiment, the holder 200 has an outer portion 210 that includes a strap securing feature 201. The strap 206 is configured to receive the strap securing feature 201 and the exhaust vent 212 in a pair of holes 202, respectively. The holes 202 hold the holder 200 in place with respect to the strap 206, as shown in FIG. 16.

The strap 206 also includes a pair of ends 203, 204 that allow the wearer to secure the strap 206 by fastening the ends 203, 204 around the wearer's head at a customized tightness. In some embodiments, the ends 203, 204 have a hook and loop fastener. In some embodiments, the ends 203, 204 include a button.

The strap 206 is constructed of a flexible material that allows air to pass therethrough. In some embodiments, the strap 206 is neoprene polychloroprene. In other embodiments, the ends 203, 204 are neoprene polychloroprene and the rest of the strap 206 is a mesh material.

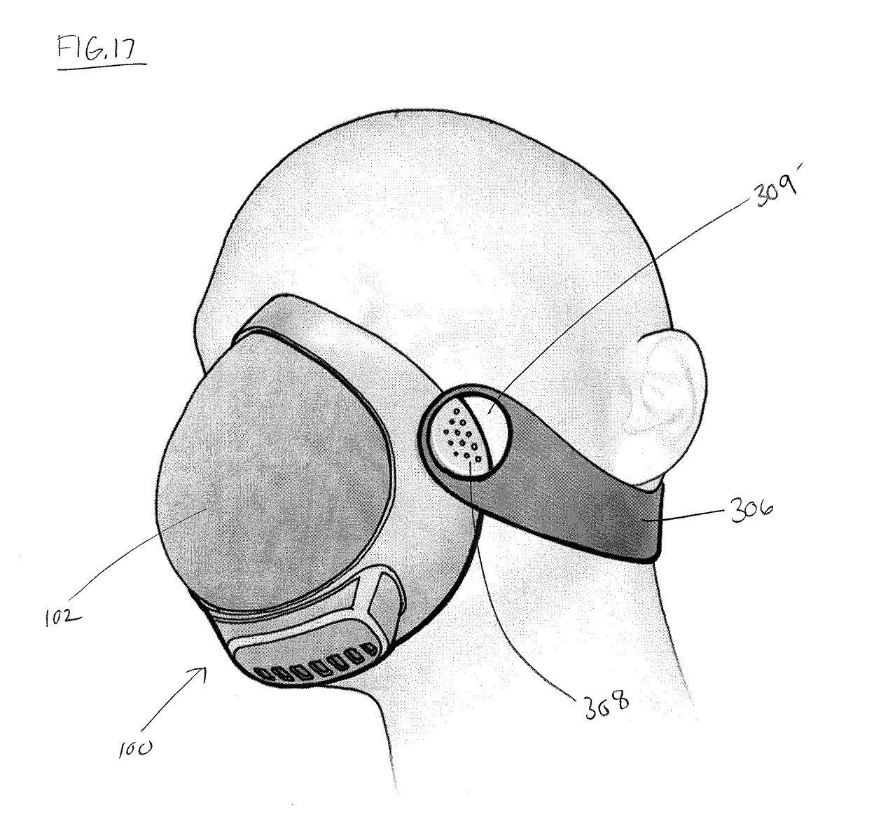

FIGS. 17-22 show a variety of different straps that are configured to the hold the holder 100, or a holder 100 similar to the holder 100, on the wearer's face. All the straps shown can either include a pair of ends that are connectable at the rear of the wearer's head, similar to the ends 203, 204 in FIGS. 15-16, or the straps can be configured to slip over the top of the wearer's head and wrap around the back side and side of the wearer's head. When slipping over the wearer's head, the straps can be manufactured in a plurality of different sizes to accommodate a variety of differently sized heads.

The straps shown in FIGS. 17-22 are also at least partially ornamental in nature and feature nonfunctional elements.

FIG. 17 shows a strap 306 that is positioned around the wearer's head, and below the ears of the wearer. The strap 306 is attached to the holder 100 at strap attachment structure 308. In some embodiments, the strap attachment structure 308 is molded as part of the holder 100. In other embodiments, the strap attachment structure 308 is attached to the holder 100. The strap 306 includes a loop 309 that is configured to be removably attached to the strap attachment structure 308. This allows the wearer to easily and quickly remove the holder 100, disposable facemask 102 and strap 306 from their head.

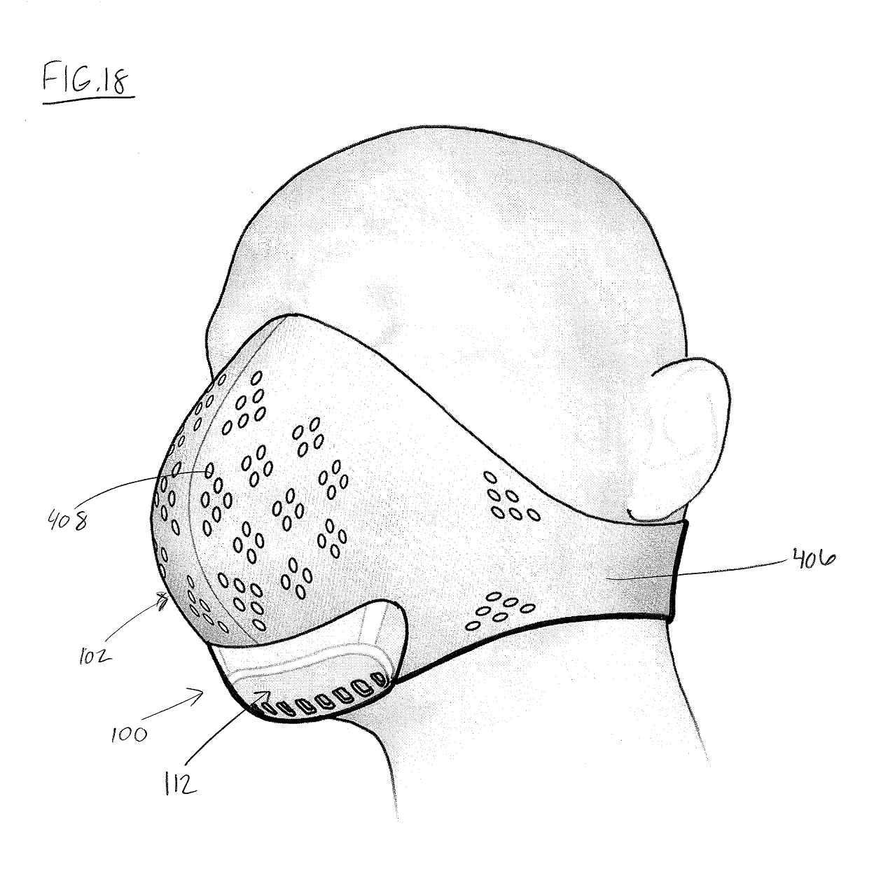

FIG. 18 shows a strap 406 that is positioned around the holder 100 and disposable facemask 102, but not the exhaust vent 112. This allows exhaled air, which is typically moist, to escape the holder 100 and the strap 406 without moisture becoming trapped within the strap 406. The strap 406 is constructed of a flexible material that allows air to pass therethrough. In some embodiments, the strap 406 is neoprene polychloroprene or mesh material. In the depicted embodiment, the strap 406 also includes a plurality of perforations 408 that allow air to more easily flow through the strap 406.

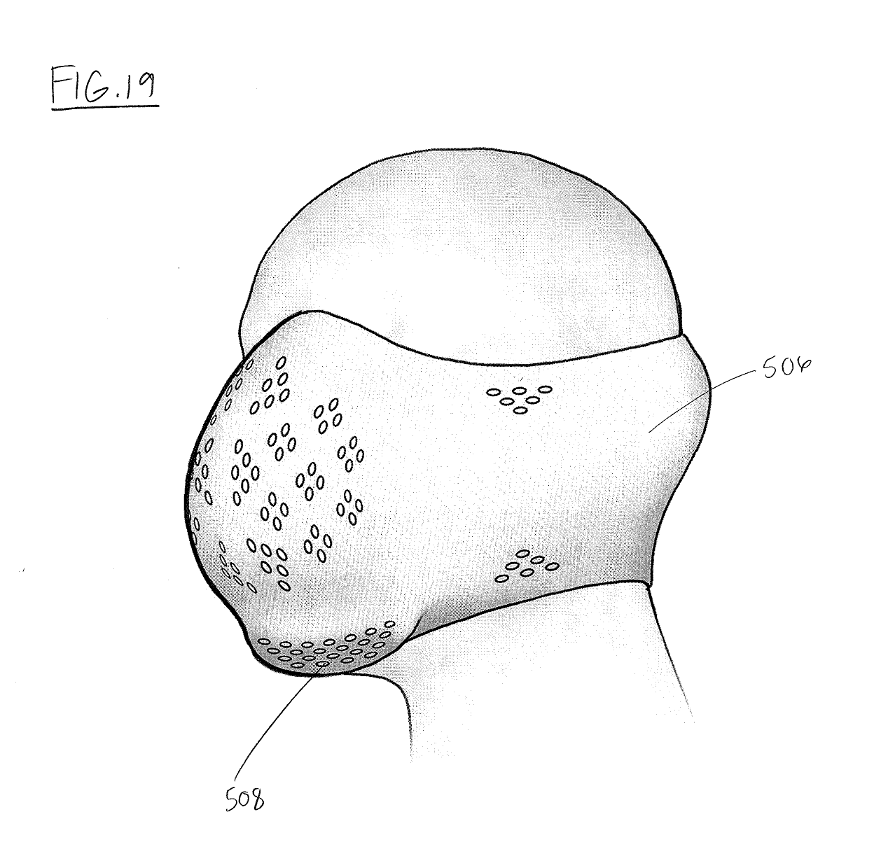

FIG. 19 shows a strap 506 that is positioned around the entire holder 100 and disposable facemask 102. The strap 406 is constructed of a flexible material that allows air to pass therethrough to minimize moisture buildup. In some embodiments, the strap 506 is neoprene polychloroprene or mesh material. Additionally, the strap 506 is positioned around the wearer's ears, making the strap 506 also double as an ear warmer for colder environments. In the depicted embodiment, the strap 506 also includes plurality of perforations 508 that allow air to more easily flow through the strap 506.

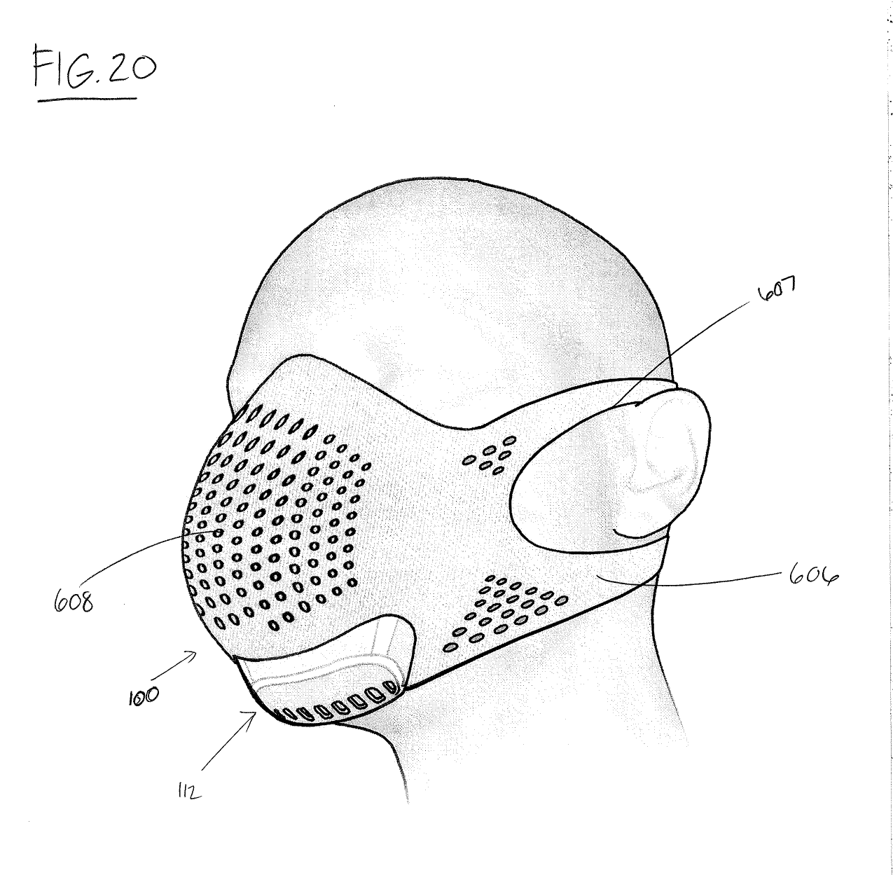

FIG. 20 shows a strap 606 that is positioned around the holder 100 and disposable facemask 102, but not the exhaust vent 112. The strap 606 includes an opening 607 for the wearer's ears. In the depicted embodiment, the strap 606 also includes a plurality of perforations 608 that allow air to more easily flow through the strap 606. Many perforations 608 are positioned on the portion of the strap 606 that covers the disposable facemask 102 to increase inhaled air flow across area.

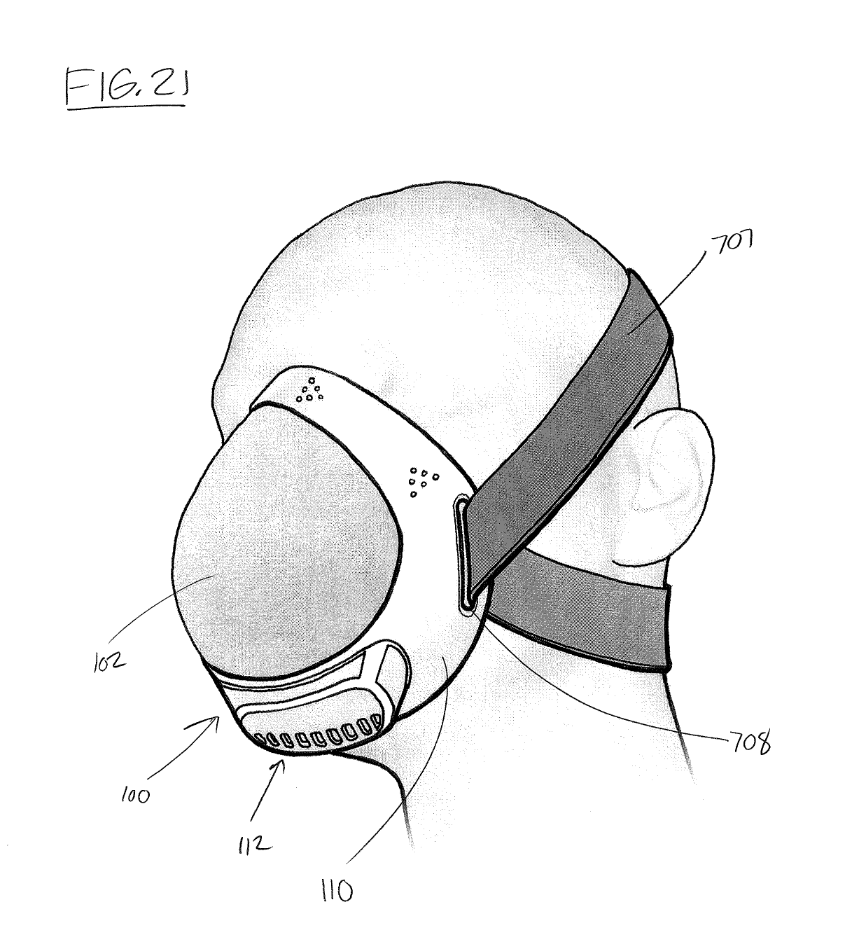

FIG. 21 shows a strap 706 that passes through a hole 708 within the outer portion 110 of the holder 100. In the depicted embodiment, the hole 708 is a slot.

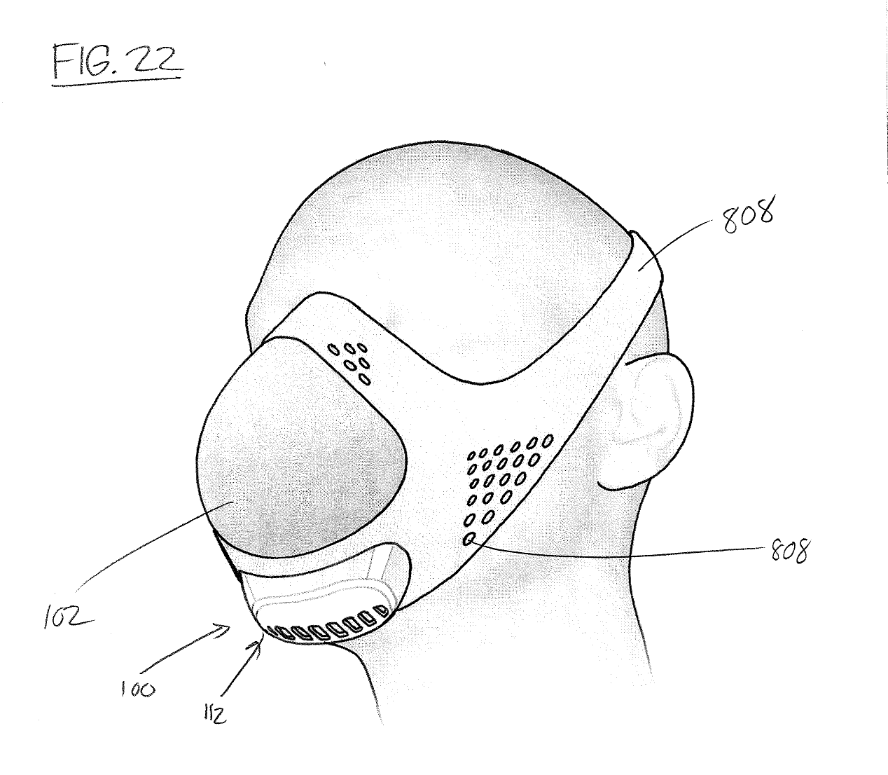

FIG. 22 shows a strap 806 that is positioned around the holder 100 but not the exhaust vent 112. Additionally, the strap 806 does not cover the disposable facemask 102. In some embodiments, the strap 806 is neoprene polychloroprene or mesh material. In the depicted embodiment, the strap 806 includes a plurality of perforations 808 that allow air to more easily flow through the strap 806.

The various embodiments described above are provided by way of illustration only and should not be construed to limit the claims attached hereto. Those skilled in the art will readily recognize various modifications and changes that may be made without following the example embodiments and applications illustrated and described herein, and without departing from the true spirit and scope of the following claims.

What is claimed is:

1. A filtering facemask holder comprising:
a first and a second body portion each having a front and a rear, and each including a central opening therethrough, the front of the second body portion being configured to receive the rear of the first body portion; and
a face seal disposed around an outer edge of the rear of the second body portion.

2. The filtering facemask holder of claim 1, wherein the first body portion and the second body portion are attached to one another by a hinge.

3. The filtering facemask holder of claim 1, wherein the hinge is a living hinge.

4. The filtering facemask holder of claim 2, wherein the hinge, first body portion, and second body portion are constructed of a single piece of material.

5. The filtering facemask holder of claim 1, further comprising an exhaust vent provided through the first and second body portions, wherein the exhaust vent is a one-way vent.

6. The filtering facemask holder of claim 5, further comprising an exhaust membrane positioned within the exhaust vent.

7. The filtering facemask holder of claim 1, wherein the first and second body portions are configured to receive a disposable facemask therebetween.

8. The filtering facemask holder of claim 7, further comprising an internal cavity surrounding the central openings of each of the first and second portion, wherein the internal cavity is defined by a recessed portion on the front of the second body portion and a surface on the rear of the first portion.

9. The filtering facemask holder of claim 7, wherein the first body portion includes a plurality of internal securing protrusions configured to retain the disposable facemask within the central opening.

10. The filtering facemask holder of claim 9, wherein the second body portion includes a lip for receiving the securing protrusions of the first body portion.

11. The filtering facemask holder of claim 1, further including a latching feature configured to removably latch the first and second body portions to one another.

12. A filtering facemask holder comprising:
a body portion having a central opening, wherein the opening is configured to hold a disposable facemask;
a one-way exhaust vent provided through the body portion; and
a face seal disposed around an outer edge of the body portion.

13. The filtering facemask holder of claim 12, further comprising a head securing strap attached to the body portion.

14. The filtering facemask holder of claim 12, further comprising an exhaust membrane positioned within the exhaust vent.

15. The filtering facemask holder of claim 12, wherein the body portion includes an internal cavity for receiving the disposable facemask.

16. A filtering facemask holder comprising:
a first and a second body portion each having a front and a rear and each including a central opening therethrough, the front of the second body portion being configured to receive the rear of the first body portion, wherein the first body portion and second body portion are pivotable about a hinge;
a face seal disposed around an outer edge of the rear of the second body portion;
an exhaust vent provided through the first and second body portions, wherein the exhaust vent is a one-way vent, and wherein the exhaust vent includes an exhaust membrane positioned therewithin; and
a head securing strap configured to secure at least the first body portion to a head of a user.

17. The filtering facemask holder of claim 16, wherein the first and second body portions are configured to receive a disposable facemask therebetween to filter air flowing through the central opening.

18. The filtering facemask holder of claim 16, wherein the first body portion includes a plurality of internal securing protrusions configured to retain a disposable facemask within the central opening.

19. The filtering facemask holder of claim 16, wherein the second body portion includes a lip configured to receive the securing protrusions of the first body portion.

20. The filtering facemask holder of claim 16, further including a latching feature configured to latch the first and second body portions to one another.
